(19) United States
(12) Patent Application Publication
(10) Pub. No.: US 2021/0340969 A1
(43) Pub. Date: Nov. 4, 2021

(54) IMPROVED MICROPUMP

(71) Applicant: MST INNOVATION GMBH, Dortmund (DE)

(72) Inventors: Frank Bartels, Hattingen (DE); Monika Kremer, Dortmund (DE); Florian Siemenroth, Dortmund (DE); Anja Strube, Dortmund (DE)

(21) Appl. No.: 17/255,355

(22) PCT Filed: Jun. 26, 2019
(86) PCT No.: PCT/IB2019/055396

§ 371 Date: Jul. 20, 2021

(30) Foreign Application Priority Data
Jun. 26, 2018 (DE) 10 2018 115 328.7

(51) Int. Cl. F04B 43/04; F04B 53/10; F04B 13/00; F16K 99/00

(52) U.S. Cl. CPC F04B 43/046; F04B 53/10; F16K 2099/0094; F16K 99/0015; F16K 99/0048; F04B 13/00

(57) ABSTRACT

The micropump including a pump chamber which can be fluidly filled or emptied both by means of a passage opening and an inlet, the pump chamber being covered with a disk-shaped actuator so that the volume of the pump chamber can be changed by deflecting the actuator, the passage opening being arranged in a side of the pumping chamber opposite the actuator, and the inlet has a smaller or similar flow resistance compared to the through opening. An entrance to the passage opening can be closed by means of the deflected actuator, so that a valve is formed in the basic state, or closed by means of the undeflected actuator, so that a valve is formed in the basic state. The micropump can have a second pump chamber with an actuator and inlet, the passage opening of which is connected to that of the first pump chamber.

### CROSS REFERENCE TO RELATED APPLICATIONS

This is a a U.S. national phase application under 35 U.S.C. § 371 of PCT/IB2019/055396 filed Jun. 26, 2019, which claims priority from German patent application No. 10 2018 115 328.7, filed Jun. 26, 2018, each of which is herein incorporated by reference in its entirety.

### TECHNICAL FIELD

The invention relates to the field of micropumps. In particular, the invention relates to a micropump for conveying gases and liquids, and an associated method for conveying gases and liquids with a micropump.

### PRIOR ART AND DISADVANTAGES

Micropumps are well known in the art. According to one definition, they are used to convey fluids (liquids and gases) of small volumes. These are typically in the range of micro- to milliliters per minute.

In addition to the amount of fluid delivered per unit of time, however, the size of the pump, in particular its pump housing, can also be decisive in determining whether a micropump is present. Thus, the term “micropump” also describes a particularly small housing having edge lengths in the range from a few millimeters to a few centimeters. Components such as the power supply and control are often housed separately from said housing, which is why the term “micropump” in the narrower sense is limited to the components required for the actual pumping (pump chamber, valves, housing). Such a micropump in particular is also the subject of the invention at hand.

Such a pump is known from patent document EP 2 222 959 B1, which stems from the present applicant. It comprises the following components: a lower housing part with inlet and outlet; a valve foil; a central part which provides openings for connection of the valves to the pump chamber; an actuator foil with two piezo actuators; as well as a housing cover.

As can be seen immediately, the pump comprises a not insignificant number of components that have to be positioned exactly and partially also have to be connected to one another. In particular, the foil that provides the moving parts of the valves must be manufactured and positioned very precisely and connected to the adjoining parts in order to ensure the desired function.

During operation of the micropump, the valves limit the pumping frequency due to their inertia. In addition, they are exposed to constant, mostly high-frequency loads, which is demanding with regard to their mechanical properties. Another disadvantage is the noise emissions caused by the drive of the pump. At frequencies above approx. 300 Hz, these are clearly audible even with small geometries, and at frequencies above approx. 1000 Hz, the noise emission increases to a level that is intolerable in many application scenarios. Operation above the hearing threshold of approx. 20 kHz is not possible due to the inertia of the valves.

Furthermore, micropumps are known which dispense with mechanical valves. Instead, they are operated in a narrow frequency range, preferably the first or higher order resonance frequency. They are designed in such a way that fluid dynamic effects become relevant at the operating frequency, which result in the formation of a preferred direction when conveying the fluid. Thus, from publication DE 11 2013 002 723 T5, publication US 2011/0076170 A1 and publication US 2016/0377072 A1 micropumps are known which are operated at high frequencies, preferably in the inaudible range. The single actuator which is present in the form of a piezo disk is attached to a membrane which provides passage openings for the fluid to be conveyed. Chambers filled with fluid are present on both sides of the membrane. The flow conditions during operation of the pump result in a fluid resistance of different magnitude in the corresponding chamber depending on the direction of vibration of the membrane. In this way, the fluid is conveyed in the desired conveying direction.

The main disadvantage of such arrangements is the fact that their operating frequency is in a relatively narrow range, since otherwise no satisfactory preferred direction does develop during conveying. Along with this, the delivery rate is also essentially defined. It is hardly possible to change the same, since the fluid-dynamic valve function can no longer be realized if the oscillation frequency and/or the operating voltage are reduced.

A disadvantage of this, as well as other micropumps known from the prior art, is also the inadequate metering or delivery accuracy. In certain cases, especially in the field of diagnostics and therapy, it is important to dose even very small amounts of fluid exactly. The actuator connected to the pump membrane oscillates between two end deflections during operation. The volume of the pump chamber adjoining the actuator changes from a minimum to a maximum and back. The difference between the two end deflections determines the maximum fluid volume that can be conveyed per stroke. Accordingly, the position of said end deflections and their reproducibility in successive strokes are of decisive importance with regard to the metering accuracy. The more precisely it is possible to keep the two end deflections constant, the more similar the volume of successive strokes will be.

In fact, it is difficult to keep said end deflections constant. Slight voltage fluctuations can result in different strokes. Changes in temperature can result in different stiffnesses of the moving parts. Also, manufacturing tolerances that can hardly be avoided, especially of the actuators, lead to different results in micropumps within a series with regard to the delivery volume that can be achieved per stroke.

The object of the invention is therefore to provide an improved micropump and an improved method for operating a micropump which avoids the disadvantages of the prior art.

Accordingly, the number of components should be kept low. The individual components should be easy to assemble. The pumping operation should be possible over a large delivery rate range. The load on the valves should be reduced.

The delivery volume that can be achieved per stroke should be independent of the manufacturing tolerances, in particular of the actuators.

### OBJECT OF THE INVENTION

Thus, the invention is based on the object of providing a device and a method which avoid the disadvantages of the prior art.

### SUMMARY OF THE INVENTION

First, a micropump according to the invention is described. This is followed by the description of the method according to the invention for operating the same.

The invention relates to a micropump with a small housing size, as described above. It comprises a pump chamber which can be fluidly filled or emptied both by means of a passage opening and an inlet. The pump chamber, viewed along its longitudinal axis, can have a rectangular, but preferably a round, cross section.

The pump chamber is covered with a disk-shaped actuator, so that the volume of the pump chamber can be changed by deflecting the actuator. The actuator is preferably a piezo actuator, which can optionally be attached to a support membrane; the latter is defined here as belonging to the actuator. A deflection of a disk-shaped actuator leads to bulging of the same. In an undeflected resting position, such an actuator is essentially flat. It is clear that the actuator can preferably also be deflected in the opposite direction, which leads to a greater difference between the two achievable limit volumes of the pump chamber. The actuator can also be constructed based on another principle, for example electromechanically. In this case, the component determining the volume is the wall adjoining the pump chamber, which can also be a membrane, for example.

The passage opening is arranged in a side of the pump chamber opposite the actuator so that an entrance to the passage opening can be closed by means of the deflected or undeflected actuator, depending on the design variant, so that a valve is formed. The valve can therefore be actively opened and closed. If the passage opening is closed in the deflected state of the actuator, it is a valve that is open in the basic state (“normally open variant”). If the passage opening is closed in the undeflected state of the actuator, it is a valve that is closed in the basic state (“normally closed variant”). In fact, the presence of the valve is merely a result of the inventive arrangement of the entrance of the passage opening and of the deflected or undeflected actuator; the invention accordingly provides a valve function without the need for additional components typically required for this (separate actuator, valve flaps, possibly specific flow dynamics of a passive valve).

In addition, the inlet has a smaller or similar flow resistance compared to the passage opening. The difference is preferably a factor of 1.0 to 10. This means that pressurized fluid preferably leaves the pump chamber through the passage opening or flows into it, provided that the entrance is open (the actuator is not completely deflected). Thus, a further, but passive valve that does not have any moving parts is provided which—when inlet and entrance are open—gives a preferred direction to the fluid flow. It is clear that when the entrance is closed, no such preferred direction is present.

The micropump according to the invention also has a second pump chamber with an actuator and inlet, the passage opening of this further pump chamber being connected to that of the first pump chamber.

By suitably controlling the actuators, it is possible to provide a peristaltic pump which is equipped with two chambers. Its functioning is described in detail below.

Thus, the invention avoids the drawbacks known from the prior art.

A micropump constructed according to the invention has a very small number of individual parts. Due to the symmetry, the number of different parts is reduced. Assembly is easy because e.g. there is no need to precisely insert a valve foil. The number of joints is also greatly reduced. The pumping frequency is no longer limited by the inertia of separate valves. There is also no noise generated by said valves, as is the risk of failure of the same. Due to the use of two separately drivable pump chambers, it is possible to decouple the natural frequency from the achievable pump frequency; the micropump can be operated in a wide frequency range. This means that the delivery rate can also be set over a wide range.

Various embodiments of the invention are described in more detail below.

According to one embodiment of the micropump according to the invention, the same is characterized in that it has a second such pump chamber with all the features as described above.

According to one embodiment, the following is true:

If an entrance to the passage opening is closed when the actuator is in the deflected state, it is a valve that is open in the basic state (“normally open variant”). In this case, the actuator is spaced apart from the opposite side of the respective pump chamber in a resting position.
If an entrance to the passage opening is closed in the undeflected state of the actuator, it is a valve that is closed in the basic state (“normally closed variant”). In this case, the actuator is in a resting position on the opposite side of the respective pump chamber.

The micropump according to this embodiment is characterized in that the actuator is assigned to an end stop which mechanically limits the stroke of the actuator in at least one of its (main) directions of oscillation. This means that the actuator is mechanically limited in its freedom of movement in at least one of its two essential directions of oscillation, i.e. the direction(s) of oscillation which is or are required for conveying. In other words, at least one of the two above-mentioned end deflections is defined by the position of the end stop and is not caused by the “unimpeded” end position of the freely oscillating actuator, which is slightly different from actuator to actuator despite otherwise identical ambient conditions (temperature, voltage, manufacturing tolerances). The provision of a suitable end stop, which results in a defined position of the end stop of the actuator, is easier to achieve in terms of manufacturing compared to an actuator of constant quality.

Above all, however, the position of the final deflection of an actuator can be precisely defined in a simple and inexpensive manner. Thus, the delivery volume per stroke becomes independent of the end position of a freely oscillating actuator, which is slightly different from actuator to actuator, even when obtained under otherwise identical environmental conditions (temperature, voltage, manufacturing tolerances). Likewise, micropumps within a series show a significantly lower spread in terms of their delivery volumes per stroke, and thus a more consistent quality.

According to a further embodiment, the both actuators can be controlled in a very specific way.

Firstly, this relates to the waveform of the control. In particular, a square wave, but preferably a sinusoidal wave and a trapezoidal wave, i.e. a wave with a level which is rising, then constant, and then dropping again, may be considered as waveforms. The preferred waveforms have, inter alia, the advantage of lower noise generation during operation.

Further, this also applies to the phase position or the phase shift. Accordingly, a phase shift other than 180° can be effected between the two waves. In fact, the present micropump would not work if its two actuators were being controlled just alternately, i.e. with a phase shift of 180°. Tests have shown that a phase shift of 90° generally leads to good results. Surprisingly, however, it was also found that, depending on the specific design of the micropump, a value deviating from this downwards, for example 70°, 75°, 80°, 85°, or a value deviating to higher values, for example 95°, 100°, 105°, 110°, can lead to even better work results (pump performance). This is particularly the case when the two pump chambers are constructed not completely identical, but slightly “asymmetrically” (for example different volumes, actuators, . . . ).

The control frequency of the actuators is preferably in the range from 1 Hz to 100 kHz, and preferably in the range from 50 Hz to 25 kHz.

According to a preferred embodiment, the micropump comprises a control unit, or such a control unit is assigned to the micropump. The control unit generates the above mentioned alternating voltages which correspond to the specific waveforms and which can be passed on to the two actuators for driving them. It also has the possibility of adjusting the phase shift, at least in the range as specified above. The phase shift is particularly preferably reversible as well (e.g. −90° instead of +90°.

According to one embodiment, the two pump chambers are positioned opposite one another and are fluidically connected to one another by means of the common passage opening. In this way a very compact micropump is provided. In addition, the connecting passage opening can then be provided having a minimal length, which ensures both a lower dead volume and better flow properties.

According to another embodiment, the two pump chambers are arranged next to one another. In this way, a particularly flat design can be achieved.

Another advantage of this embodiment is the possibility of being able to carry out the assembly completely from one side.

According to a further embodiment, the passage opening is arranged in the center of the according pump chamber's side which is opposing to the actuator. In particular when a disk-shaped, round actuator is used, its maximum deflection occurs in the center of the disk. It is therefore sensible to also place the passage opening or the entrance in the center of that side which is opposite the actuator. However, it is also possible to arrange the entrance at a different position; it is only important that the actuator closes or can close said entrance in the deflected or undeflected state, depending on the variant.

It should be noted that a closure is also considered to be sufficient if there is a certain residual gap through which—in relation to the inlet, which will be discussed further below—only small amounts of fluid can flow. It is clear that the sealing effect can be increased by a suitable choice of material or coating of the actuator (inside) and/or the entrance of the passage opening. In addition, by choosing a softer material, the noise that may be generated when the entrance is closed by the actuator can be further reduced. It should be added, however, that the development of noise can largely be suppressed solely by the construction according to the invention in connection with a suitable “soft” deflection of the actuator, in particular near its maximum deflection. For this purpose, the deflection velocity must be reduced accordingly close to the maximum deflection.

According to one embodiment, the undeflected actuator is spaced apart from the pump chamber's side opposing to the same, so that a “real” pump chamber having a volume greater than zero is achieved. This means that the actuator forms a delimitation of the pump chamber in the resting position, and a second delimitation different therefrom is present, and at least some distance is present between the two delimitations, so that a positive volume is present between the two delimitations which is not equal to or close to zero, but forms a significant proportion of the volume moved in a single stroke.

For example, the actuator can form the base of a dome-shaped, hemispherical or cylindrical volume (first boundary), and the remaining area of the dome, hemisphere or cylinder provides the second boundary. The pump chamber then has the volume of the corresponding inner space.

It is clear that this embodiment can be implemented both in the case of an actuator having a planar shape in the resting position, as well as with a shape being non-planar, for example domed (spherical segment-like), in the resting position.

According to one embodiment with an end stop as defined above, the undeflected actuator is spaced apart from the pump chamber's side opposite to the same, so that a “real” pump chamber with a volume greater than zero is formed, the end stop being formed by the side against which the actuator can be rested mechanically at minimal stroke by means of control, i.e., at minimal stroke in the direction of this side, resting at the same, so that the volume of the pump chamber can be minimized in a defined manner. The end stop can therefore also be referred to as the “inside end stop”.

This in turn means that the actuator forms a delimitation of the pumping chamber in the resting position, and a second delimitation different therefrom is present, and at least some distance between the two delimitations exists so that there is a positive volume between the two delimitations which is not equal to or close to zero, but forms a significant proportion of the volume moved in a single stroke.

This further means that the side of the interior of the pump chamber facing the actuator serves as the mechanical stop. The actuator can be controlled (i.e. operated with such a high voltage, for example) that it approaches this side until physical contact is established, i.e. the stroke is minimal. Preferably, the stroke would be deflectable even further without the obstacle of the end stop, so that it can be ensured that the actuator is actually always positioned at the end stop when being in the deflected state, preferably exerting a certain pressure on it, so that always the end stop specifies the end position of the actuator, thus becoming independent of manufacturing tolerances etc. of the actuator.

According to another embodiment, the undeflected actuator rests against the pump chamber's side opposing to the same, so that a “flat” pump chamber with a volume of, or close to, zero is achieved. Contrary to the embodiment described above, the first and second delimitation rest against one another, or they are only at a negligibly small distance away from one another. It is clear that in terms of design, a small gap between them can hardly be avoided; however, a pump chamber according to this embodiment has a residual or dead volume in the undeflected position of the actuator which is negligibly small with respect to the proportion of the volume actually moved during a single stroke.

It is again clear that this embodiment can be realized both with an actuator having a planar shape in the resting position, as well as with an actuator which is non-planar, having e.g. a dome-like (spherical segment-like) arched shape in the resting position. It is vital that the shape of the side of the pump chamber opposite the actuator is designed at least essentially in accordance with the shape of the undeflected actuator.

According to another embodiment with an end stop according to the above definition, the undeflected actuator also rests on the pump chamber's side opposite to the same, so that in the undeflected state a “flat” pump chamber exists having a volume of, or almost of, zero, wherein the end stop, against which the actuator can be rested mechanically by means of control, is located on the side of the actuator which faces away from the pump chamber, so that the actuator rests against the end stop at maximum stroke in direction of the end stop, and so that the volume of the pump chamber can be maximized in a defined manner. The end stop can therefore also be referred to as “outside end stop”.

Contrary to the embodiment described above, the first and second delimitation rest against one another, or they are only at a negligibly small distance away from one another. It is clear that a small gap between them can hardly be avoided in terms of design; however, a pumping chamber according to this embodiment has in fact a residual or dead volume in the undeflected position of the actuator, which is however negligibly small, compared to the proportion of the volume actually moved during a single stroke.

Contrary to the previously described embodiment, the end stop is now arranged on the “outside” of the actuator. It can be provided, for example, by a cage, a correspondingly narrow outer housing, or a stop screw. It should be made so stiff that it does not deform, or not deform significantly, when mechanical contact with the outside of the actuator is established. Contact is established when the actuator is at its maximum distance from the opposite side of the pump chamber, that is, the pump chamber has maximum volume. The advantages result in analogy to the previous embodiment with an inner end stop.

It is again clear that this embodiment can be realized both with an actuator having a planar shape in the resting position, as well as with an actuator which is non-planar, having e.g. a dome-like (spherical segment-like) arched shape in the resting position. It is vital that the shape of the side of the pump chamber opposite the actuator is designed at least essentially in accordance with the shape of the deflected actuator.

According to one embodiment of the micropump, the same comprises both a pump chamber according to the above definition of a “real” pump chamber having an inner end stop, as well as an outer end stop according to the above definition of a “flat” pump chamber. In other words, the actuator is prevented from (further) free movement at minimum stroke or in its minimum deflection by the opposite inner wall of the pump chamber, and in the case of a maximum stroke or in its maximum deflection it is stopped by the “external” mechanical end stop prevented from (further) free movement. The advantage of this embodiment is that both end positions of the actuator can be precisely defined, so that the entire (possibly bilateral) stroke, and thus the volume that can be conveyed, is exactly defined. This is particularly advantageous when the actuator oscillates back and forth between two non-planar geometrical planes, i.e. neither of the two end positions corresponds to the typically planar, stress-free resting position.

According to a further embodiment of the micropump, the same comprises only one pump chamber according to the definition of a “real” pump chamber having an inner end stop, or only one pump chamber according to the definition of a “flat” pump chamber having an outer end stop, or just a combination of these two definitions (i.e. a real pump chamber with inner and outer end stop), the usable volume of this (first) pump chamber being less than or equal to the usable volume of the second pump chamber, which is also present. In other words, a first pump chamber is designed according to one of the preceding embodiments, and the second pump chamber is of a different design, i.e. does not have a corresponding end stop.

This embodiment can be used advantageously when the micropump is intended to convey in only one conveying direction, namely from the pump chamber according to one of the above definitions (first pump chamber) to the second pump chamber of a different type. The defined pumping volume per stroke is then precisely specified by the pump chamber having an end stop as defined above. The pump chamber of a different design can therefore no longer convey more than the pumping volume made available to it, so that the same remains precisely defined.

According to another embodiment of the micropump, the same has two pump chambers according to one of the preceding definitions (pump chamber with an inner and/or outer end stop). In other words, the two pump chambers are largely identical. They can preferably be designed mirror-symmetrically. The advantage of this embodiment is that the conveying direction can be reversed in a simple manner; since the delivery volumes of both pump chambers can be precisely defined (via the respective end stops), it is irrelevant which is passed through by the fluid at first, and which afterwards.

According to a further embodiment, the side of the pump chamber opposite the actuator which has the passage opening has the negative shape of the deflected (normally open variant) or the undeflected (normally closed variant) actuator, at least in the area of the passage opening. This means that by adapting the entrance of the passage opening to the curvature of the actuator at the appropriate location (e.g. in its center), the tightness of the valve is improved.

This also includes the reverse case, according to which the actuator is adapted to the entrance at least in the corresponding contact area.

According to a further embodiment, also the inlet is arranged on the side opposite to the actuator. Thus, the actuator can not only close and open the entrance, but also the inlet. Depending on the location of the inlet, it can be closed simultaneously, before, or after the entrance. An earlier closability is advantageous because then the fluid loss due to undesired backflow is reduced, which cannot be completely avoided with a purely passive valve (difference of flow resistance between passage opening and inlet).

According to a particularly preferred embodiment, the pump chamber's side which is opposing to the actuator and which comprises the passage opening has completely (or essentially completely) the negative shape of the deflected actuator (normally open variant) or undeflected actuator (normally closed variant). In this way, the minimum volume, and thus the dead volume, of the pump chamber can be reduced to almost zero. In addition, the required housing size is also minimized.

In case of a “real” pump chamber, the shape of the side opposite the actuator essentially corresponds to the shape of the deflected actuator. In the case of a “flat” pump chamber, the shape of the side opposite the actuator essentially corresponds to the shape of the actuator in the resting position. Typically this side has a concave curvature in the first case and is flat in the second case; however, other shapes are also possible (see above).

According to one embodiment, the respective inlet runs perpendicular to the passage opening. If the passage opening runs, for example, along a longitudinal axis of the micropump, the inlets run approximately transversely to the same. This allows a particularly space-saving arrangement of the two inlets, which preferably run in opposite directions.

According to a further embodiment, the respective inlet runs at least in its inner end region approximately parallel to the plane of the actuator. This means that in the case of a pump chamber covered on “top” with the actuator, it opens “laterally” into this pump chamber.

As already noted above, the present invention relates to a micropump with a small housing. Thus, the micropump must be clearly differentiated from pumps of a larger design; also because the requirements of such large pumps differ significantly from those of the smallest designs.

Specifically, a housing of the micropump that comprises the actuators is no larger than 5 cm×2 cm×1 cm, and preferably 12 mm×12 mm×2.5 mm. The housing only has to comprise the components that are essential for the actual conveying (pump chambers and actuators), but not further components such as an energy storage or an energy supply or a control unit.

According to another embodiment, the housing has a cylindrical basic shape with a diameter of not more than 3 cm, preferably 2 cm, and particularly preferably 1.5 cm, and a height of not more than 2 cm, and preferably 1 cm, and particularly preferred 0.75 cm.

According to a further embodiment of the micropump, the same has a sensor on at least one of the actuators for detecting the impact of its side facing the pump chamber. This means that, by evaluating the signal generated by this sensor, it can be determined if or that the said impact occurs. A control with end stop can, as explained above, be desirable. The impact can be checked by means of the sensor.

A passive “control piezo” or, for example, a strain gauge can be used as a sensor.

The invention also relates to a valve system for controlling a fluid flow, comprising the components of a micropump according to the above definitions, the valve system comprising four stages, which are defined by the inlet and the first actuator, the first actuator and the passage opening, the passage opening and the second actuator, and the second actuator and the inlet are formed.

In other words, a micropump of the type according to the invention can also be used as a four-stage valve system. Such a valve system has the advantage of particularly high safety in order to avoid undesired fluid flow, since it comprises a large number of stages. At the same time, the valve system can be used as a micropump. It is clear that this embodiment is advantageously formed with “normally closed” pump chambers so that no energy is required when the valve system is closed. However, the reverse is also possible.

The invention also relates to a method for operating a micropump as described above.

At first, the system is in an initial state. In principle, this can be any of the states described below; it can therefore be selected arbitrarily, and is determined in the following so that a particularly understandable description of the process steps is made possible.

Accordingly, the initial state is the state in which both actuators are controlled in such a way that the volumes of the pump chambers are minimal and the respective entrances to the passage opening and the inlets are closed. With piezo actuators, in case of the normally open variant, both actuators are in a driven, curved state; in case of the normally closed variant, both actuators are in an essentially flat (non-driven) state.

A pumping cycle then comprises the following steps:

1. Increasing the distance of the first actuator to the side opposing to the same, so that the volume of the first pump chamber increases and the first inlet as well as the first entrance to the passage opening are opened, so that fluid can flow through the first inlet into the first pump chamber and fill the same due to the thus formed underpressure.

“Increasing the distance” means that the deflection is changed in such a way that the volume of the pump chamber increases. It is therefore clear that—depending on the type of actuator—“relaxation”, but also an increase in its deflection, can lead to an increase in the pump chamber volume; for example, when the actuator is in a resting position at the entrance and is deflected by activation (e.g. applying a voltage) so that it moves away from the entrance, as is the case with the normally closed variant.

2. Simultaneously reducing the distance of the first actuator to the side opposing the same and increasing the distance of the second actuator to the side opposing the same, so that also the second entrance to the passage opening is open, and the volume of the first pump chamber is reduced, and, at the same time, the volume of the second pump chamber is increased, so that the fluid can flow from the first pump chamber via the common passage opening into the second pump chamber, the first being emptied and the second being filled.

In this way, the fluid is continuously “shifted” from the first to the second pump chamber. During the shifting, both entrances to the passage are open; only at the very beginning is only the first entrance open and the second (still) closed, so that no fluid can (yet) flow. At the very end, the first entrance is (already) closed and only the second is open, so that no fluid can flow (any more).

Preferably, the first inlet is opened as early as possible in the case of negative pressure (suction phase) and is closed early during shifting.

Preferably, the second inlet remains closed for as long as possible during shifting, and is opened as early as possible in the presence of excess pressure (output phase).

3. Reducing the distance of also the second actuator, so that the volume of the second pump chamber is minimized and the fluid is emitted through the second inlet due to the forming overpressure, and the pump arriving again in its initial state.

By repeating steps 1, 2 and 3, a quasi-continuous conveying of fluid is made possible. The fluid is conveyed into the first inlet, through both pump chambers, and out through the second inlet.

If, however, the steps are not repeated, the micropump has dispensed the smallest possible amount of liquid in a metered manner. The volume that can be conveyed with the aid of the micropump according to the invention is, depending on the operating voltage and stroke volume, typically in the range of 0.01 μl and 50 μl per stroke, and preferably between 0.1 μl to 2.0 μl per stroke.

According to one embodiment for a micropump with end stop, at least the first actuator, when it moves in the direction of the respective end stop, is driven in such a way that it establishes mechanical contact with the end stop, so that its stroke is limited in a defined manner. This means that at least one of the actuators has at least one of the end stops according to the above definition, so that the volume that can be conveyed by this actuator is defined by means of the end stop and is no longer directly dependent on the quality etc. of the actuator (see above).

Of course, a pump chamber can also have both of the end stops described, and both pump chambers can also be configured in such a way that a micropump with up to four end stops is used.

Both actuators according to the invention are accordingly driven by a rectangular wave, a sinusoidal wave, or a trapezoidal wave. The two actuators are preferably operated with a phase shift of ±90°.

The phase shift can, however, be in a range from ±70° to ±120°; reference is made to the explanations given above. Furthermore, it is also possible to go through the steps described one-by-one, with both actuators only moving at the same time during “shifting”.

By increasing the pumping frequency, the delivery rate is increased. Conversely, the minimum delivery rate is only limited by the volume of both pump chambers, i.e. the amount conveyed that is delivered by the micropump in a single cycle.

The micropump is particularly preferably operated with a sinusoidal wave-form, a frequency of 300 Hz, and a phase offset of preferably ±(70°−110°) or particularly preferably ±90°.

If (i) the steps are carried out in reverse order, or (ii) the phase shift is changed in a suitable manner, the fluid is conveyed into the second inlet, through both pump chambers, and out through the first inlet. For this purpose, the phase shift is adapted by aid of a suitably controllable control unit. If, for example, a phase shift of +90° results in a conveyance in a first conveyance direction, a reversal in the opposite conveyance direction is achieved by negating this value to −90° . The micropump according to the invention thus offers the possibility of a reversal of the direction of conveyance in a surprisingly simple manner, namely due to its controllability by means of a changed phase shift (also: phase offset, phase difference). It is clear that a direction reversal according to the invention is only possible using a micro-pump with two practically identical pump chambers. Reference is made to the explanations given above.

According to one embodiment of the method according to the invention, the delivery rate per time unit corresponds to the product of the volume of the pump chambers and the number of cycles per time unit. In other words, the delivery rate increases proportionally with the volume that can be conveyed per stroke and the pumping frequency. This applies in particular to the method for operating the micropump according to the invention, described in detail above and comprising three “cycles”.

According to a further embodiment, both actuators are driven by means of a sinusoidal, trapezoidal or square-wave voltage, the phase shift of which is 90° ±20° or 270±20° degrees, the stroke of the actuator being limited to 75%±20%. Tests have surprisingly shown that a good delivery rate can be achieved even with a limitation of the stroke of the actuator or actuators as mentioned above.

According to a preferred embodiment, the micropump is operated with a frequency which corresponds to the (then particularly preferably identical) resonance frequency of the actuators, since the stroke of the actuators is then very large with little energy consumption. Operation at the second, third or higher harmonic is also possible. It is only necessary to ensure that the entrances can be adequately closed.

The resonance frequency can be increased by using stiffer or smaller discs. Operation at the resonance frequency is advantageous because the voltage required for operation is lower than in operation outside the resonance frequency. According to one embodiment, the resonance frequencies of the actuators can be changed, for example by mechanically reducing/increasing the oscillatable area (e.g. reducing/increasing the diameter). It should be added that the micropump according to the invention can also be operated at a frequency other than the resonance frequency. Thus, and since the pump can advantageously also be operated with the harmonic of the first or higher degree with respect to the resonance frequency, different operating frequencies and thus delivery rates are possible without structural changes.

According to a further embodiment of the method, which can also be combined with a pump chamber with an outer end stop, a distance between the actuator and the opposite side of the pump chamber remains at all times when the micropump is in operation. This means that the actuator (or the membrane assigned to it, see above) does not touch the opposite side, and therefore neither touches the entrance of the passage opening nor the inlet, thus covering it (i.e. there is also no inner end stop). Although the delivery rate or the achievable pump pressure is reduced due to the non-closing of said openings, experiments have surprisingly shown that the micropump according to the invention nevertheless achieves a usable delivery rate and at an acceptable pump pressure. The advantage of this embodiment is that it is less susceptible to manufacturing tolerances or geometry changing operating conditions, because the micropump still works sufficiently well when the aforementioned openings are no longer sealed, or it does not need said closure at all. The dosing accuracy is further improved by the outer end stop.

According to one embodiment, the micropump according to the invention is used for gaseous fluid. In the case of gases in particular, the noise problems described in the introduction are most severe. Accordingly, the micropump according to the invention can be used particularly advantageously in this field of application because it generates little noise. The low level of noise development is made possible by dispensing with separate mechanical valves. This in turn allows operation at high frequencies in the inaudible ultrasound range. However, also the use of other than square waves to control the actuators, such as sinusoidal waves, allows a significant reduction in the sound volume that occurs during operation.

According to another embodiment, the micropump is used for liquids.

Finally, the invention also relates to the use of a micropump as defined above as a multi-stage valve system having four closures. Reference is made to the explanations given above.

### BRIEF DESCRIPTION OF DRAWINGS

The invention is explained below by way of example with reference to figures. It is shown by

FIG. 1 the micropump of a first variant in an idle state;

FIG. 2 this micropump according to the invention in an initial state which is at the same time the end of the emission process;

FIG. 3 this micropump according to the invention at the end of the suction process;

FIG. 4 this micropump according to the invention at the end of the shifting process;

FIG. 5 the micropump of a second variant in a resting position which is at the same time the end of the emission process;

FIG. 6 this micropump according to the invention at the end of the suction process;

FIG. 7 this micropump according to the invention at the end of the shifting process;

FIG. 8 this micropump according to the invention in a “normally-open-state”;

FIG. 9 the micropump of a third variant in a resting position which is at the same time the end of the emission process;

FIG. 10 this micropump according to the invention at the end of the suction process;

FIG. 11 this micropump according to the invention at the end of the shifting process;

FIG. 12 this micropump according to the invention in a “normally-open-state”;

FIG. 13 an embodiment of a micropump with two pump chambers, wherein only one pump chamber has an outer end stop;

FIG. 14 an embodiment of this micropump with an adjusting device;

FIG. 15 an example of the change in the flow rate and direction of conveyance when the phase shift of both actuators changes.

### DETAILED DESCRIPTION

In FIG. 1, the micropump according to the invention is shown in an idle state. This is a “normally open variant” of the micropump according to the invention, in which the actuators do not close the entrances in the basic state, so that fluid can flow through the pump.

In the present case, the micropump is constructed symmetrically and is therefore suitable for conveyance in both directions. It has two pump chambers 11, 12. It also includes two inner end stops 61′, 62′; the inner sides 61, 62 of the two pump chambers 11, 12 serve this purpose.

Parts that are not essential for understanding the invention, such as electrical leads, seals and the like, have been omitted for reasons of clarity.

The idle state shown is characterized in that both actuators 11, 12 are in a resting position. In the exemplary embodiment, the actuators 11, 12 are designed as piezo disks which are applied to a membrane (black area). According to the definition, the two components each result in an actuator 11, 12.

Each actuator 11, 12 covers a pump chamber 21, 22, thus delimiting and defining its volume. If the deflection of an actuator 11, 12 changes, i.e. if the distance between the actuator 11, 12 and the respective side 61, 62 increases, this changes the volume of the respective pump chamber 21, 22, as will be shown below. In the center of each pump chamber 21, 22, namely on the side 61, 62 opposite the respective actuator 11, 12 which presently serves as an (inner) end stop 61′, 62′, an entrance 31, 32 to the passage opening 4 is positioned. The passage opening 4 fluidly connects the two pump chambers 21, 22 to one another.

Furthermore, an inlet 51, 52 is also present in each pump chamber 21, 22, which connects it to the adjacencies, and at the distal end of which, for example, a hose fixation or the like can be attached (not shown).

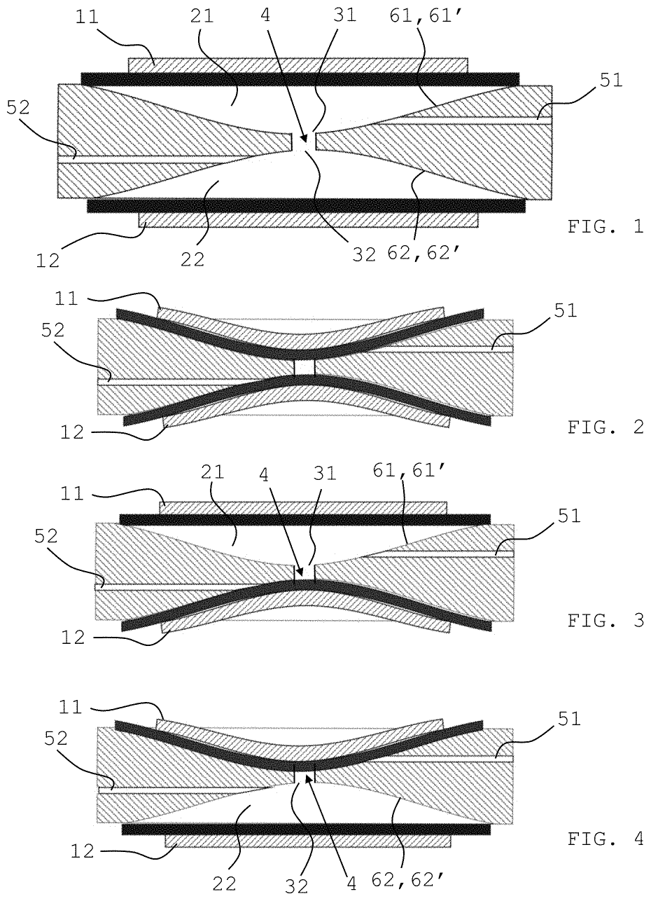

In FIG. 2, both actuators 11, 12 are shown in a deflected position. In the present case, this state is referred to as the “initial state”, which is at the beginning of each pump cycle of this variant of the micropump.

As can now be seen, the shape of the side 61, 62 opposite the respective actuator 11, 12 (“bottom” of the pump chamber) corresponds to the negative of the shape of the deflected actuator 11, 12. In this way, almost the entire amount of fluid (not shown) is pressed out of the two pump chambers 21, 22, and the dead volume is minimized.

The two sides 61, 62 also serve as inner end stops 61′, 62′; by mechanical contact of the actuator 11, 12 with the corresponding side 61, 62, the end positions of the actuators 11, 12 are mechanically determined, and the end positions are independent from the actuators insofar as it is only necessary to ensure that each actuator 11, 12 in the depicted minimum position is actually in contact with the respective end stop 61′, 62′ (side 61, 62).

The two entrances 31, 32 (reference numbers omitted) are closed by the actuators 11, 12 in the initial state. The two inlets 51, 52 are also closed by them.

In the present case, the two actuators 11, 12 are prevented from further movement (bulging in direction of the center of the micropump) by the corresponding inner end stop 61′, 62′ (sides 61, 62).

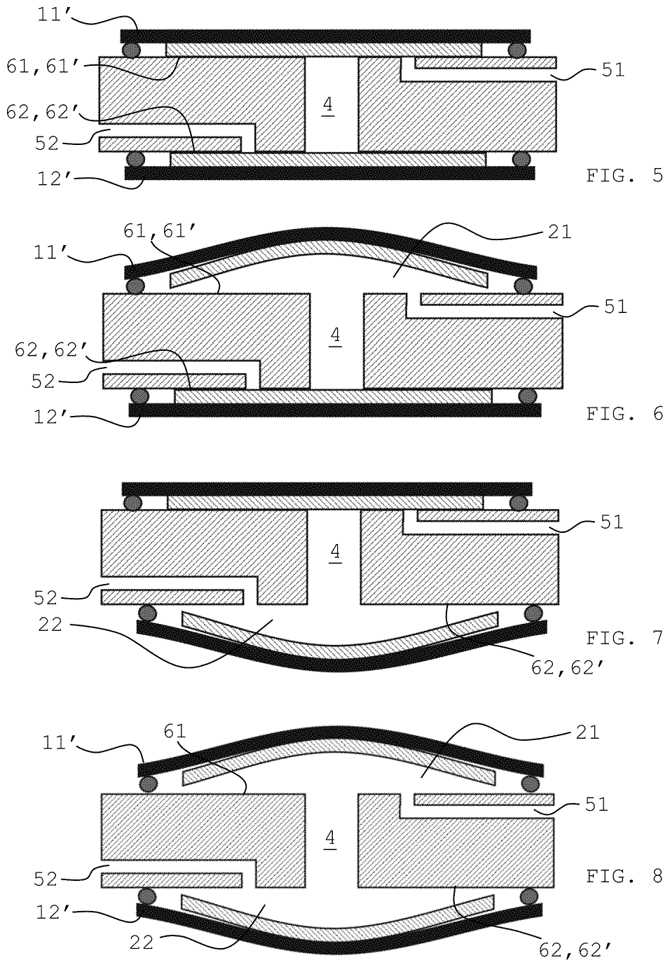

In FIG. 3, the state is shown as it appears at the end of the suction process. In this state, the first actuator 11 has relaxed, i.e. it has moved from the deflected position into its (in the present case flat) resting position. Actuator 12 further remains in the deflected position, in the present case in physical contact with its end stop 62′. By increasing the volume of the first pump chamber 21, a negative pressure is created. This leads to fluid flowing through inlet 51 into the pump chamber 21. It is clear that the actuator 11 could also swing further outwards in order to further increase the volume of the pump chamber 21 (not shown). However, a further, external end stop would then preferably be present (see FIGS. 5-8).

FIG. 4 shows the state at the end of shifting the fluid from the first pump chamber 21 into the second pump chamber 22. When the second actuator 12 begins to move out of its minimally deflected end stop position (see FIG. 3, “minimal” always means “most closely to the end stop”) in direction of its resting position, the second entrance 32 is first opened; by successively moving actuator 12 further, the second pump chamber 22 is gradually enlarged. By simultaneous, successive deflection of the first actuator 11 from the resting position to its minimally deflected position, the fluid is now pushed through the passage opening 4, which is open on both sides, until the first pump chamber 21 is emptied and its volume is minimized. In this position, the first actuator 11 closes the entrance 31 again.

Finally (not shown in FIG. 4) the second actuator 12 also moves back into its minimally deflected position, in the present case up to the corresponding end stop 62′ (side 62). Since the first actuator 11 has already closed the passage opening 4, the fluid can now only escape through inlet 52; the micropump conveys the fluid. One pumping cycle is complete, the two actuators 11, 12 are again in the initial position shown in FIG. 2, and the micropump is again in the defined initial state.

A conveying cycle thus comprises 3 “cycles”, as shown in FIGS. 2 to 4.

FIGS. 5 to 8 show a “normally closed” variant of the micropump according to the invention.

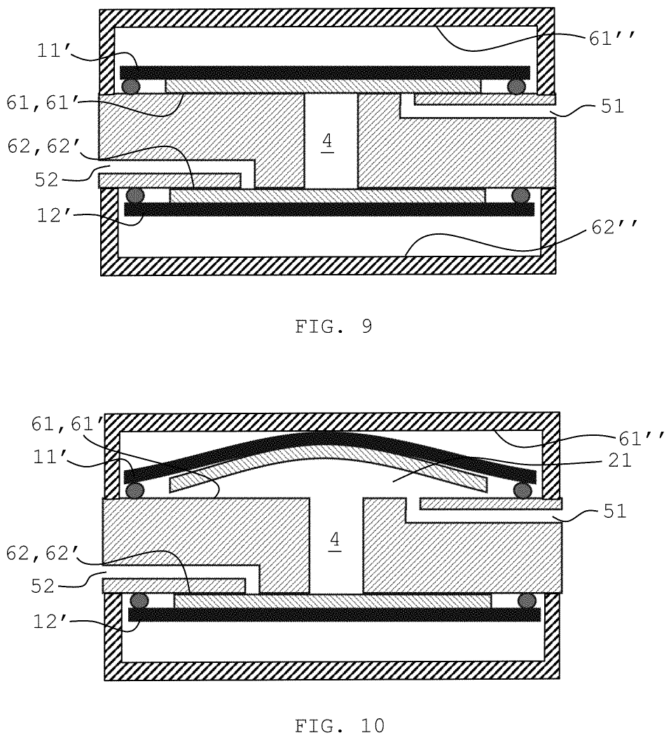

FIG. 5 shows the micropump in an idle state. In this state, both actuators 11′, 12′ rest on the respective sides 61, 62. The pump chambers 21, 22 (reference numbers see FIGS. 6 and 7) have a minimum volume. Sides 61, 62 also serve as inner end stops 61′, 62′.

At the end of the suction process, which is shown in FIG. 6, the first actuator 11′ has maximally moved away from the opposite side 61 and thus the end stop 61′. The volume of the first pump chamber 21 is at its maximum. The fluid has flowed in through inlet 51. Since the second actuator 12′ rests still flat on the side 62 and thus the end stop 62′, the passage opening 4 is closed there; fluid cannot therefore flow back from inlet 52.

The micropump according to the invention is shown in FIG. 7 at the end of the shifting process. Analogous to the shifting process of the “normally open” variant described above, the fluid was shifted from the first pump chamber 21 into the second pump chamber 22 here too. For this purpose, the distance between the first actuator 11′ and the side 61 or the end stop 61′ is successively reduced, while the distance between the second actuator 12′ is gradually increased until the state shown in FIG. 7 is obtained.

Subsequently, the second actuator 12′ also goes into its resting position again, so that the initial state shown in FIG. 5 results. Meanwhile, the volume of the second pump chamber 22 is reduced so that the fluid can only take the path out of the micropump through inlet 52.

Thus, the conveying cycle of this embodiment also comprises 3 “cycles”, as shown in FIGS. 5 to 7.

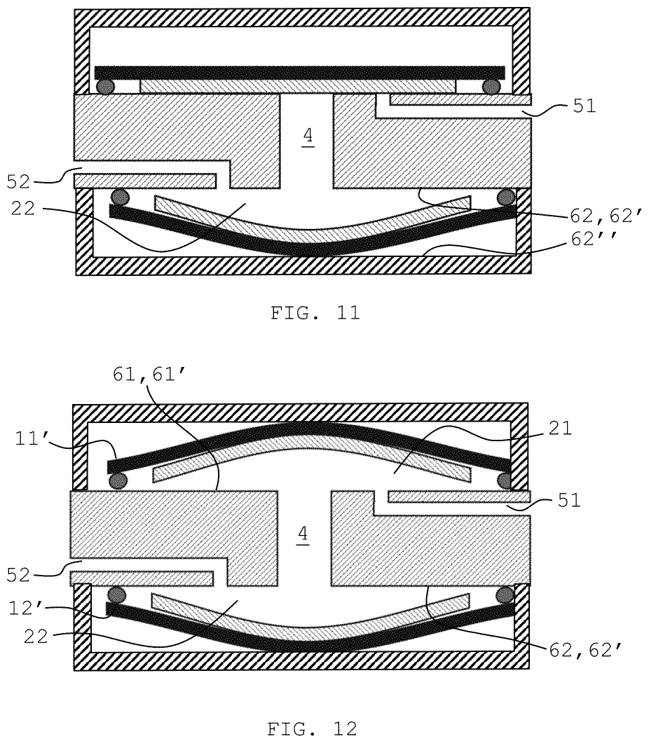

For the sake of completeness, FIG. 8 shows the positions of the two actuators 11′, 12′ of the second variant when this is in a “normally open” state. It is clear, however, that in the basic state, typically planar actuators can remain in said position only when energy is supplied. Thus, if such a state is desired as the basic state, the “normally open” variant described above is more advantageous.

The frequency of the micropump or the control of the actuators 11, 12, respectively, is, for example, 25 kHz, the actuators are then typically being operated in a harmonic of the first degree. The diameter of the preferably disk-shaped actuator is, for example, 12 mm.

FIGS. 9 to 12 show a further embodiment of a “normally closed” variant of the micropump according to the invention. On the outward-facing sides of the actuators 11′, 12′, a mechanical outer end stop 61′, 62′ is schematically shown. This prevents the respective actuator 11′, 12′ from moving freely (further) so that its maximum deflection (i.e. the deflection furthest away from the respective end stop) is mechanically specified. Sides 61, 62 serve as inner end stops 61′, 62′.

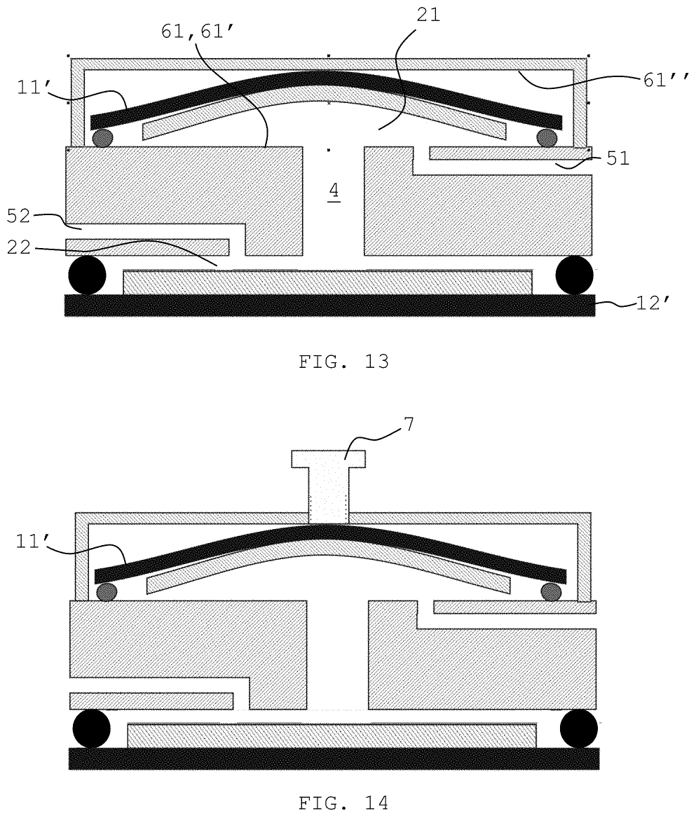

FIG. 9 shows the micropump in an idle state. In this state, both actuators 11′, 12′ rest on the respective sides 61, 62, but not against the respective external end stop 61″, 62″. The pump chambers 21, 22 (reference numbers see FIGS. 10 and 11) have a minimum volume.

At the end of the suction process, which is shown in FIG. 10, the first actuator 11′ has maximally moved away from the opposite side 61 and is in contact with outer end stop 61″. The volume of the first pump chamber 21 is at its maximum and defined by the outer end stop 61″, which specifies the end position for actuator 11′. The fluid has flowed in through inlet 51. Since the second actuator 12′ is still flat against the side 62 and thus against inner end stop 62′, the passage opening 4 is closed there; thus, fluid cannot flow back from inlet 52.

In FIG. 11, the micropump according to the invention is shown at the end of the shifting process. Analogous to the shifting process of the “normally open” variant described above, here too, the fluid was shifted from the first pump chamber 21 into the second pump chamber 22. For this purpose, the distance between the first actuator 11′ and the side 61 is successively reduced, while the distance between the second actuator 12′ is successively increased until the state shown in FIG. 11 is obtained, in which the end position of the second actuator 12′ is specified by the corresponding outer end stop 62″.

Subsequently (not shown) also the second actuator 12′ takes its resting position again, so that the initial state shown in FIG. 9 is obtained again. Meanwhile, the volume of the second pump chamber 22 is reduced so that the fluid can only take the path out of the micropump through inlet 52.

Thus, the conveying cycle of this embodiment also comprises 3 “cycles”, as shown in FIGS. 9 to 11.

For the sake of completeness, FIG. 12 shows the positions of the two actuators 11′, 12′ of this embodiment when being in a “normally open” state. It is clear, however, that in the basic state, typically planar actuators can only take said position when energy is supplied. Thus, if such a state is desired as the basic state, the “normally open” variant described above with “real” pump chambers is more advantageous.

FIG. 13 shows an embodiment of the micropump with two pump chambers 21, 22, only one pump chamber 21 having an inner end stop 61′ and an outer end stop 61″. The pump chamber 21 in the picture above has an actuator 11′ which, in the maximum deflection shown, rests against the outer end stop 61″. Actuator 12′, on the other hand, has no such inner or outer end stop. Since, when actuator 11′ is in operation, the volume it conveys is defined by the outer end stop 61″ and the inner end stop 61′, only this volume can be further conveyed by subsequent (downstream) actuator 12′. It must only be ensured that said second actuator 12′ and the associated pump chamber 22 are suitable and set up to actually convey a volume of this size. Preferably, the actuator can also convey an at least slightly (e.g. +5%, +10%, +20%) larger volume. In the present case, the conveying direction is from pump chamber 21 into pump chamber 22. It is indicated in FIG. 13 that actuator 12′ is larger and thicker than actuator 11′, so that a larger volume can also be conveyed with the same. It also has no end stop, because in the resting position shown, its side which points upward in the Figure and which faces pump chamber 22 is spaced apart from the pump chamber's 22 side which is opposite this side. So both sides are not in contact with one another; even if actuator 12′ is deflected, it will not lie flat against the side of the pump chamber 22. There is also no external end stop for actuator 12′.

The embodiment according to FIG. 14, in which the reference symbols have largely been omitted, has an adjusting device 7, shown schematically, for subsequent, simple adjustment of the position of maximum deflection of actuator 11′. This position is adjustable in direction of actuator 11′, whereby the end position of the same can be varied within certain limits.

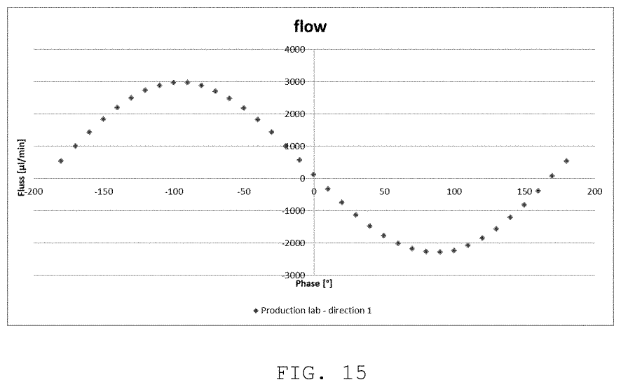

FIG. 15 shows an example of the change of flow rate and conveying direction when the phase shift (also: phase difference) changes between the activation of both actuators. Both actuators are driven with a sinusoidal voltage of the same frequency (here: 300 Hz) and amplitude (here: 250 Vpp). The numbers on the Y-axis are only to be understood qualitatively in the present case, while the numbers on the X-axis represent concrete values for the phase shift of the voltage curves of the control voltages of both actuators. The diagram shows that with a phase shift of 0° or ±180°, the delivery rate becomes zero. In the first case, both actuators oscillate in unison, in the second case in push-pull.

With a phase shift of +90°, the delivery rate reaches a negative maximum. In this case, actuator 11, 11′ leads actuator 12, 12′; the conveying direction is then from inlet 51 to inlet 52. With a phase shift of −90°, the delivery rate reaches a positive maximum. In this case, actuator 11, 11′ follows actuator 12, 12′; the conveying direction is then from inlet 52 to inlet 51; consequently the conveying direction is exactly the opposite.

It can also be seen that by varying the phase shift around a value of ±90°, a reduced delivery rate occurs.

However, depending on the design, the positive or negative maximum can also be at other values, for example at ±70°, ±80°, ±100°, or ±110°. This can be the case if the two pump chambers are not completely identical, but are constructed slightly “asymmetrically”. This can be the case, for example, due to different volumes of the pump chambers, actuators that differ from one another, different flow resistances of the respective inlets, etc. Such differences may be intentional; however, they typically result from production-related variations of the respective components. However, the invention makes it possible to compensate for the disadvantageous result of such undesirable but unavoidable variations by adjusting the phase shift. Instead of cost-intensive measures to further improve, for example, the similarity of the actuators, the joining technology, or the manufacturing process, the delivery rate can be optimized by simply adapting the control of the actuators. In addition, subsequent variations, for example due to different aging, or variations that arise under different operating conditions (pressure, temperature, viscosity of the conveyed medium, . . . ), can be readjusted in situ, which would otherwise not be possible.

### LIST OF REFERENCES

11, 12, 11′, 12′ actuator
21,22 pump chamber
31,32 entrance
4 passage opening
51,52 inlet
61,62 side
61′,62′ end stop, inner end stop
61″,62″ end stop, outer end stop
7 adjusting device

What is claimed is:

1. Micropump having a small housing size, comprising a pump chamber (21), which can be fluidically filled or emptied by means of a passage opening (4) as well as an inlet (51), wherein the pump chamber (21) is covered with a disk-shaped actuator (11; 11′), so that the volume of the pump chamber (21) can be changed by deflecting the actuator (11; 11′), wherein the passage opening (4) is arranged in a side (61) of the pump chamber (21) which is opposing to the actuator (11; 11′), and wherein the inlet (51) has, compared to the passage opening (4), a smaller or similar flow resistance, and wherein one entrance (31), with respect to the passage opening (4),
can be closed by means of the deflected actuator (11), so that a valve is formed which is open in a basic state, or
can be closed by means of the undeflected actuator (11′), so that a valve is formed which is closed in a basic state,
characterized in that the micropump has a second pump chamber (22) with actuator (12; 12′) and inlet (52), the passage opening (4) of which being connected to the one of the first pump chamber (21).

2. Micropump according to claim 1, wherein the second pump chamber (12, 12′) is formed identical to the first pump chamber (11, 11′).

3. Micropump according to claim 1 or 2, wherein
can be closed by means of the deflected actuator (11, 12), so that a valve which is open in an basic state is formed, wherein in a resting position, the actuator (11, 12) is spaced apart from the opposing side (61; 62) of the according pump chamber (21, 22), or
is closed by means of the undeflected actuator (11′, 12′), so that a valve which is closed in an basic state is formed, wherein in a resting position, the actuator (11′, 12′) rests against the opposing side (61, 62) of the according pump chamber (21, 22), characterized in that an end stop (61′, 62′) is assigned to the actuator (11, 12; 11′, 12′), which mechanically limits the stroke of the actuator (11, 12; 11′, 12′).

4. Micropump according to claims 1 to 3, wherein its respective actuators (11, 12, 11′, 12′)
can be driven by means of a rectangular wave, a sinusoidal wave, or a trapezoidal wave, wherein
a phase shift different from 180° can be effected.

5. Micropump according to claim 4, wherein the pump comprises a control unit by means of which the actuators (11, 12, 11′, 12′) can be driven by means of a rectangular wave, a sinusoidal wave, or a trapezoidal wave, wherein a phase shift different from 180° can be effected between the two waves.

6. Apparatus according to any of the preceding claims,
wherein both pump chambers (21, 22) are positioned (i) opposing one another or (ii) next to each other, and respectively fluidically connected to each other by the common passage opening (4), and/or
wherein the passage opening (4) is arranged in the center of the according pump chamber's (21, 22) side (61, 62) which is opposing to the actuator (11, 12; 11′, 12′).

7. Micropump according to any of claims 1 to 6, wherein the undeflected actuator (11, 12) is spaced apart from the pump chamber's (21, 22) side (61, 62) opposing to the same, so that a pump chamber (21, 22) with a volume larger than zero is achieved.

8. Apparatus according to claim 3 and claim 7, wherein the end stop (61′, 62′) is formed by the side (61, 62) against which the actuator (11, 12) can be mechanically rested by means of control, such that the volume of the pump chamber can be minimized in a definable way.

9. Micropump according to any of claims 1 to 6, wherein the undeflected actuator (11′, 12′) rests against the pump chamber's (21, 22) side opposing to the same, so that a pump chamber (21, 22) with a volume of zero is achieved.

10. Micropump according to claim 9, wherein the end stop (61″, 62″) against which the actuator (11′, 12′) can be mechanically rested by way of control is located at the side of the actuator (11′, 12′) which is facing away from the pump chamber (21, 22), so that the volume of the pump chamber (21, 22) can be maximized in a definable way.

11. Micropump according to any of claim 8 or 10, wherein the same comprises a pump chamber (21, 22) according to definition in claim 8, as well as an end stop (61″, 62″) according to definition in claim 10.

12. Micropump according to any of claim 8 or 10, wherein the same comprises
only one pump chamber (21) according to definition in claim 8, or only one pump chamber (21) according to definition in claim 10, or one pump chamber (21) with end stop (61″) according to definition in claim 11,
wherein its usable volume is smaller or equal to the usable volume of the second pump chamber (22).

13. Micropump according to any of claims 8, 10 and 11, wherein the same comprises two pump chambers (21, 22) according to definition in claim 8, or two pump chambers (21, 22) according to definition in claim 10, or two pump chambers (21, 22) according to definition in claim 11.

14. Micropump according to any of the preceding claims, wherein the pump chamber's (21, 22) side (61), 62) which is opposing to the actuator (11, 12; 11′, 12′) and which comprises the passage opening has, at least in the region of the passage opening (4), the negative shape of the undeflected actuator (11′, 12′).

15. Micropump according to any of the preceding claims, wherein the inlet (51, 52) as well is located in the side (61, 62) which is opposing to the actuator (11, 12; 11′, 12′).

16. Micropump according to any of the preceding claims, wherein the pump chamber's (21, 22) side (61, 62) which is opposing to the actuator (11, 12; 11′, 12′) and which comprises the passage opening, has entirely the negative shape of the deflected actuator (11, 12) or of the undeflected actuator (11′, 12′).

17. Micropump according to any of the preceding claims, wherein a housing which comprises the actuators (11, 12; 11′, 12′) is not larger than 5 cm×2 cm×1 cm.

18. Micropump according to any of the preceding claims, wherein the same has at least on one of the actuators (11, 12; 11′, 12′) a sensor for the detection of impact of its pump chamber (21, 22) facing side.

19. Valve system for controlling a fluid flow, comprising the components according to any of the preceding claims, wherein the valve system comprises four stages which are formed by the inlet (51) and the first actuator (11; 11′), the first actuator (11; 11′) and the passage opening (4), the passage opening (4) and the second actuator (12; 12′), as well as the second actuator (12; 12′) and the inlet (52).

20. Method for operating a micropump according to definition in any of claims 1 to 19, characterized in that, originating from an initial state in which both actuators (11, 12; 11′, 12′) are controlled in such a way that the volumes of pump chambers (21, 22) are minimal and the according entrances (31, 32) to the passage opening (4) as well as the inlets (51, 52) are closed, a pumping cycle comprises the following steps:
increasing the distance of the first actuator (11; 11′) to the side (61) opposing to the same, so that the volume of the first pump chamber (21) increases and the first inlet (51) as well as the first entrance (31) to the passage opening (4) are opened, so that fluid can flow through the first entrance (51) into the first pump chamber (21) and fill the same due to the thus formed underpressure;
simultaneously reducing the distance of the first actuator (11; 11′) to the side (61) opposing the same and increasing the distance of the second actuator (12; 12′) to the side (62) opposing the same, so that also the second entrance (32) to the passage opening (4) is open, and the volume of the first pump chamber (21) is reduced, and, at the same time, the volume of the second pump chamber (22) is increased, so that the fluid can flow from the first pump chamber (21) via the common passage opening (4) into the second pump chamber (22), the first being emptied and the second being filled;
reducing the distance of also the second actuator (12; 12′), so that the volume of the second pump chamber (22) is minimized and the fluid is emitted through the second inlet (52) due to the forming overpressure, and the pump arriving again in its initial state;
so that fluid is transported into the first entrance (51), through both pump chambers (21, 22), and out of the second entrance (52).

21. Method according to claim 20 for the operation of a micropump having at least one end stop according to definition in any of claim 3, 8, 10, 11, 12 or 13, characterized in that the first actuator (11; 11′), in a situation when it moves towards the according end stop (61′, 61″, 62′, 62″) is controlled such that it mechanically contacts end stop (61′, 61″, 62′, 62″) so that its stroke is limited in a defined way.

22. Method according to claim 20 or 21 for the operation of a controllable micropump according to definition in any of claim 4 or 5, wherein both actuators (11, 11′, 12, 12′) are accordingly controlled by a rectangular wave, a sinusoidal wave, or a trapezoidal wave, their phase shift being between 70° and 120°.

23. Method according to any of claims 20 to 23, wherein the steps
by means of changing the phase shift or
by means of inversing the control sequence
are run through in reverse order, so that fluid is transported into the second entrance (52), through both pump chambers (22, 21), and out of the first entrance (51).

24. Method according to any of claims 20 to 23, wherein the pump capacity per time interval corresponds to the product of volumes of the pump chambers (21, 22) and number of cycles per time interval.

25. Method according to any of claims 20 to 24, wherein both actuators (11, 12; 11′, 12′) are driven by means of a sinusoidal, trapezoidal, or rectangular voltage, the phase shift of which being 90°±20° or 270±20°, wherein the stroke of the actuator (11, 12; 11′, 12′) is limited to 75%±20%.

26. Method according to any of claims 20 to 25, wherein the actuators (11, 12; 11′, 12′) are operated at the resonance frequency or a second, third, or higher harmonic.

27. Usage of a micropump according to any of claims 1 to 19 as a multi stage valve system with four closures.
